(19) United States
(12) Patent Application Publication
(10) Pub. No.: US 2004/0021893 A1
(43) Pub. Date: Feb. 5, 2004

(54) System for enabling a group of printers to print a document

(76) Inventors: Chad A. Stevens, Boise, ID (US); Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/209,086

(22) Filed: Jul. 30, 2002

(51) Int. Cl. G06F 3/12; G06F 15/00; G06F 13/00

(52) U.S. Cl. 358/1.15; 358/1.16

(57) ABSTRACT

A computing system includes a group of retention printers and a computer all connected to the network system. The retention printers are logically organized into a plurality of subgroups. The computer provides a user interface that enables a user to select a subgroup and to request a document be retained at each printer in the selected subgroup. The computer is responsive to the request by transmitting a retention job that describes the document to each one of the printers in the selected subgroup.

### BACKGROUND

Today, some printers are able to locally retain print jobs indefinitely in local memory. Once a retained job is “released” by a walk-up user, the printer retrieves the job from local memory and prints one or more copies of the job. It is noted that a retained print job may or may not persist in memory after one or more copies are printed.

For ease of discussion, a printer that can retain a job and print it at the request of a walk-up user may be referred to, herein, as supporting “retention printing”. A printer that supports retention printing may be referred to herein as a “retention printer”. One example of a retention printer is described in the patent entitled “MULTIPLE COPY PRINTER WITH PRINT JOB RETENTION”, having U.S. Pat. No. 6,160,629. That patent is incorporated herein by reference.

There are a number of different types of retention printing. One type of retention printing, for example, may be referred to as “private printing”. According to private printing, a printer retains a received print job and delays printing the job until the printer receives appropriate input from a walk-up user. Upon receiving the appropriate input, the printer prints the job. The “appropriate input” may include, for example, a Personal Identification Number (PIN), password, biometric data and/or some other unique identifier or combination of identifiers.

Another type of retention printing, for example, may be referred to as “simple retention printing”. According to simple retention printing, a printer retains a received print job and does not immediately print it until a walk-up user releases the job.

For purposes of this application, a print job that invokes any type of retention printing (including the types just mentioned) may generally be referred to herein as a “retention job”. A print job that directs a printer to perform “private printing” may be referred to herein as a “retention job” or more specifically as a “private job”. A print job that directs the printer to perform “simple retention printing” may be referred to herein as a “retention job” or more specifically as a “simple retention job”. Ways are needed to increase and enhance the capability of retention printing systems.

### SUMMARY

According to one embodiment, for example, a computing system is provided. The computing system may include a group of retention printers and a computer all connected to a network system. The retention printers are logically organized into a plurality of subgroups. The computer provides a user interface that enables a user to select a subgroup and to request a document be retained at each printer in the selected subgroup. The computer is responsive to the request by transmitting a retention job that describes the document to each one of the printers in the selected subgroup.

### BRIEF DESCRIPTION OF THE DRAWINGS

FIG. 1 is high-level block diagram of a computer system that is in accordance with one embodiment of the invention;

FIG. 2A and FIG. 2B illustrate three printer subgroups;

FIG. 3 is a flow diagram illustrating, by way of example, a particular feature of a computer in the computer system;

FIG. 4 illustrates a dialog box;

FIG. 5 is a flow diagram illustrating generally the steps that may be performed by the computer;

FIG. 6 is a flow diagram illustrating, by way of example, how a user can retrieve a job from a printer in the computer system;

FIG. 7 is a block diagram of a computing system that is in accordance with a second embodiment of the invention;

FIG. 8 is a flow diagram illustrating how a computer may operate in the computer system of the second embodiment; and

FIG. 9 is a block diagram of a computing system that illustrates yet another embodiment of the invention.

### DESCRIPTION

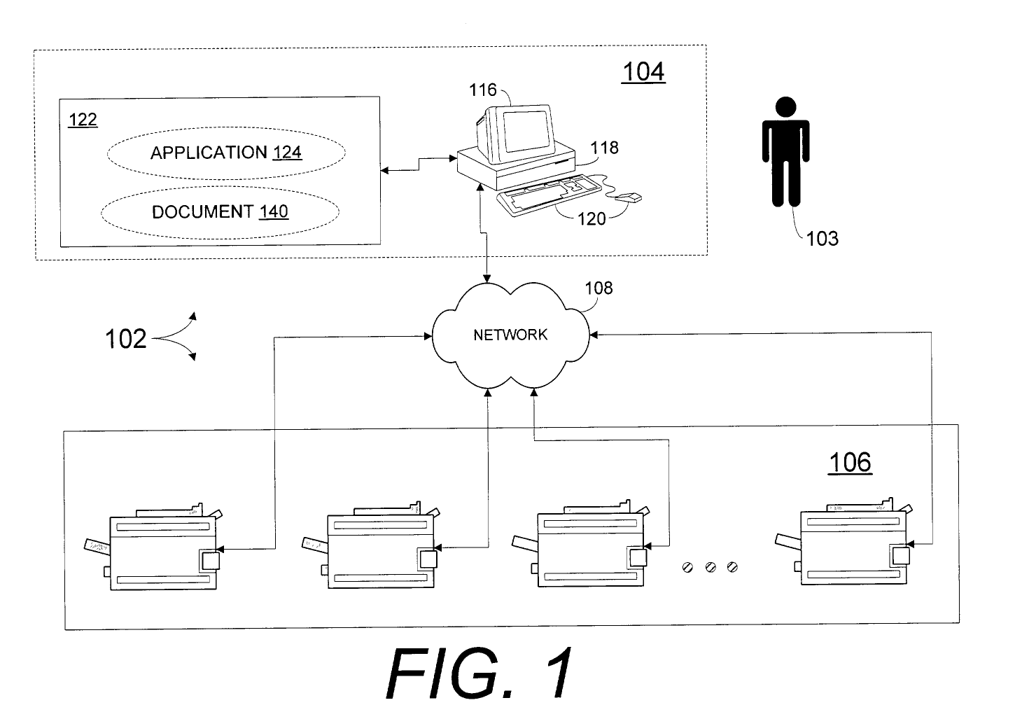

To illustrate one example embodiment of the invention, attention is first directed to FIG. 1. FIG. 1 is high-level block diagram of a computing and printing system (computer system) 102. The computer system 102 includes a computer 104 and a group of printers 106. A user 103 typically operates the computer 104.

The computer 104 can communicate with each one of the printers in the printer group 106 via a computer network 108. The computer network 108 may represent any suitable communication system. In some implementations, for example, the computer network 108 may represent an intranet and/or the Public Internet. Additionally, the computer network 108 may include wired and/or wireless aspects.

The computer 104 includes a display monitor 116, a processing unit 118, user input devices 120 and a memory 122. Stored in the memory 122 is a software application 124 and a document 140. The processing unit 118 can retrieve and execute the application 124. The application 124 may be, for example, a word processing application and one or more associated print drivers. The application 124 may have been used to create the document 140.

It is noted that the printer group 106 may include any number of printers. In this example, each of the printers in the printer group 106 supports “retention printing”. Therefore, using the terminology set forth above, each of the printers in the printer group 106 is a “retention printer”. Other types of printers (that are not members of the printer group 106) may also be connected to the network 108.

It is noted that the printers in the printer group 106 may be, for example, multifunction peripherals and have various other capabilities. For example, one or more of these printers may enable a walk-up user to scan a document, make copies of the scanned document, electronically send the document (via FAX or e-mail transmission), etc.

### Printer Subgroups

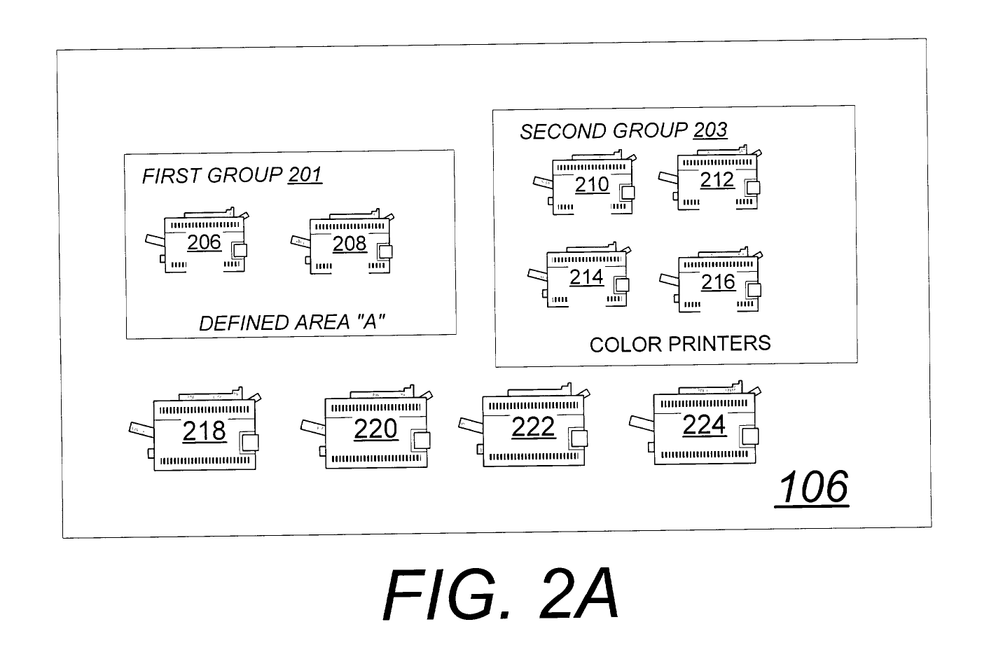

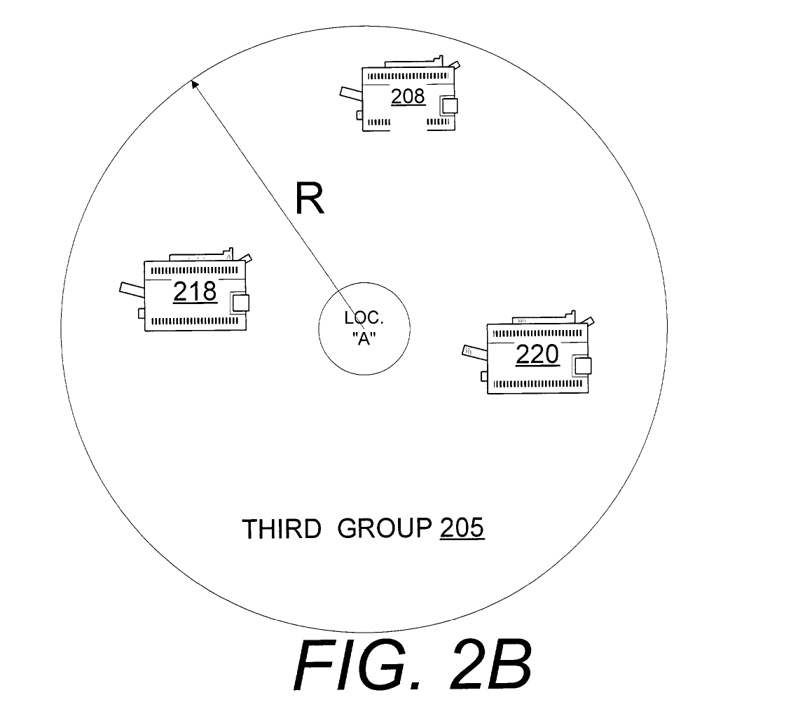

It is noted that, in this example, some of the printers in the printer group 106 are logically organized into subgroups. FIG. 2A and FIG. 2B illustrate three of these subgroups: a first printer subgroup 201, a second printer subgroup 203, and a third printer subgroup 205.

Referring to FIG. 2A, the first subgroup 201 includes those printers from the printer group 106 that are located within a particular defined area (Area “A”). For this reason, the first subgroup 201 is assigned the name “AREA A PRINTER GROUP”. “Area A” may be a particular building, a set of buildings, a floor in a building, a set of floors, etc.

As shown, the first printer subgroup 201 (i.e., the AREA A PRINTER GROUP) includes a first printer 206 and a second printer 208.

In this example, the second subgroup 203 includes those printers from the printer group 106 that can print documents in color. For this reason, the second subgroup 203 is assigned the name “COLOR PRINTER GROUP”.

As shown in FIG. 2A, the second printer subgroup 203 (i.e., the COLOR PRINTER GROUP) includes a third printer 210, a fourth printer 212, a fifth printer 214 and a sixth printer 216.

FIG. 2B illustrates the third printer subgroup 205. In this example, the third printer subgroup 205 includes those printers that are physically located within a particular radius (R) from a particular location (location “A”). Location “A” is, in this example, the present location of the computer 104. The third printer subgroup 205 is assigned the name “MY LOCAL PRINTERS” so as to indicate to a user of the computer 104 that these are printers that are relatively close to the computer 104.

As shown, the third printer subgroup 205 includes the second printer 208, a seventh printer 218 and an eight printer 220. It is noted that, in this embodiment, some of the printer subgroups overlap. It can be seen, for example, that the first printer subgroup 201 and the third printer subgroup 205 overlap as they both include the second printer 208.

It is also noted that the definition of a printer subgroup may be a system wide definition or a local definition. Thus, for example, the information that describes the name and members of the AREA A PRINTER GROUP and the COLOR PRINTER GROUP may be a system wide definition and stored on one or more network servers. The definition of these two groups may be made available, via the network 108, to the computer 104 as well as other computers on the network 108.

Furthermore, the information that describes the name and members of “MY LOCAL PRINTER GROUP” may be stored, for example, locally on the computer 104. This definition may only be available to the computer 104.

It is also noted that the printer subgroups described above are only examples of printer subgroups that may defined. In alternative implementations, for example, a printer subgroup may be based upon other criteria such as printer device type, type of network connection, print speed, share type, etc.

It is further noted that a printer subgroup definition may be created manually and/or via automated means. For example, the user of the computer 104 (e.g., the user 103) and/or a system administrator may have created one or more of the subgroup definitions in the present embodiment.

Alternatively, a subgroup definition may be created automatically by operation of the computer 104 (or some other device on the network 108). For example, the computer 104 may have performed a procedure to discover the printers in the third printer subgroup 205. According to one implementation, the computer 104 and each printer in the printer group 106 includes a GPS (global positioning system) that enables each device to determine its own position. The computer 104 operates to poll each printer over the network to determine the location of each printer in the group 106. The computer 104 then makes use of this information and the information regarding its own location to identify the printers in the printer group 106 that are located within the specified radius (“R”). Any number of other automated ways could be used to identify the members of the third print subgroup 205. For example, even printer to computer wireless transmission times could be used to determine the distance of a printer from the computer 104. It is further noted that the definition of a subgroup may also be removed/updated dynamically by operation of the computer 104 or some other computer on the network 108.

### Operation of Computer 104

In general, the application 124 enables a user of the computer 104 to create and then print documents. One particular feature of the application 124 is that it enables a user to send a retention job to any one of the defined printer subgroups.

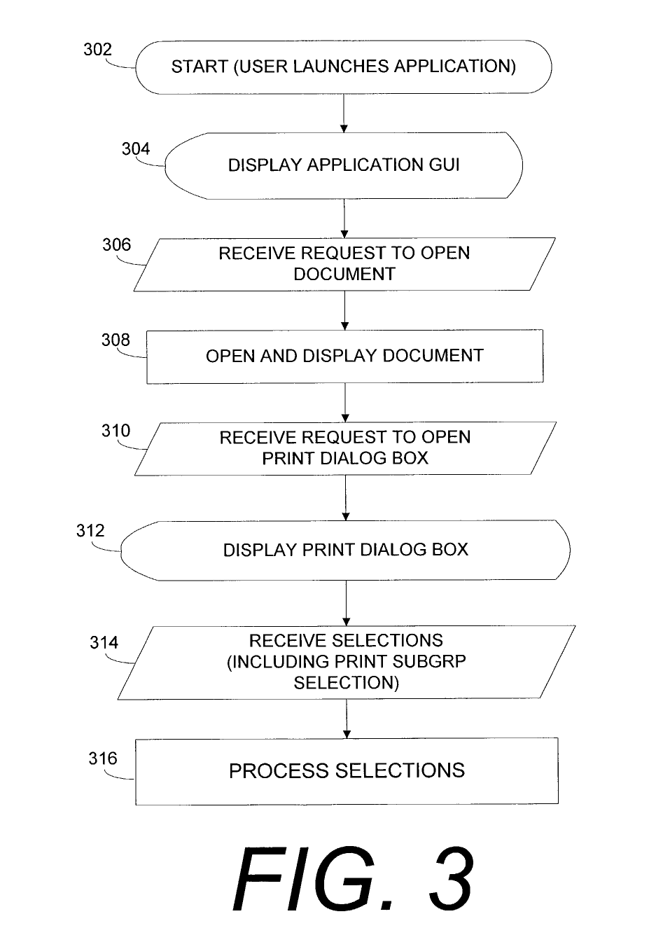

FIG. 3 is a flow diagram illustrating, by way of example, this particular feature. As the steps in FIG. 3 are explained it will be assumed that the user 103 is operating the computer 104 and that he/she provides certain input.

Turning now to FIG. 3, the user 103 interacts with the computer 104 to launch the application 124 (step 302). Upon being launched, the application 124 operates to display an initial graphical user interface (application GUI) (step 304).

The application GUI may provide various menus and options. A user can interact with the application GUI to create a new document or open/modify an existing document.

At step 306, the application 124 receives a request from the user 103 to open the document 140 that is presently stored in the memory 122. The application 124 responds to the request by opening and displaying the document 140 (step 308).

At step 310, the user 103 provides the appropriate input to cause the application 124 to display a particular dialog box. In response to the user input, the application 124 displays the dialog box (step 312).

In general, the dialog box displayed at step 312 enables a user to select a defined printer subgroup and to then request that the document 140 be retained on each of the printers that are members of this group.

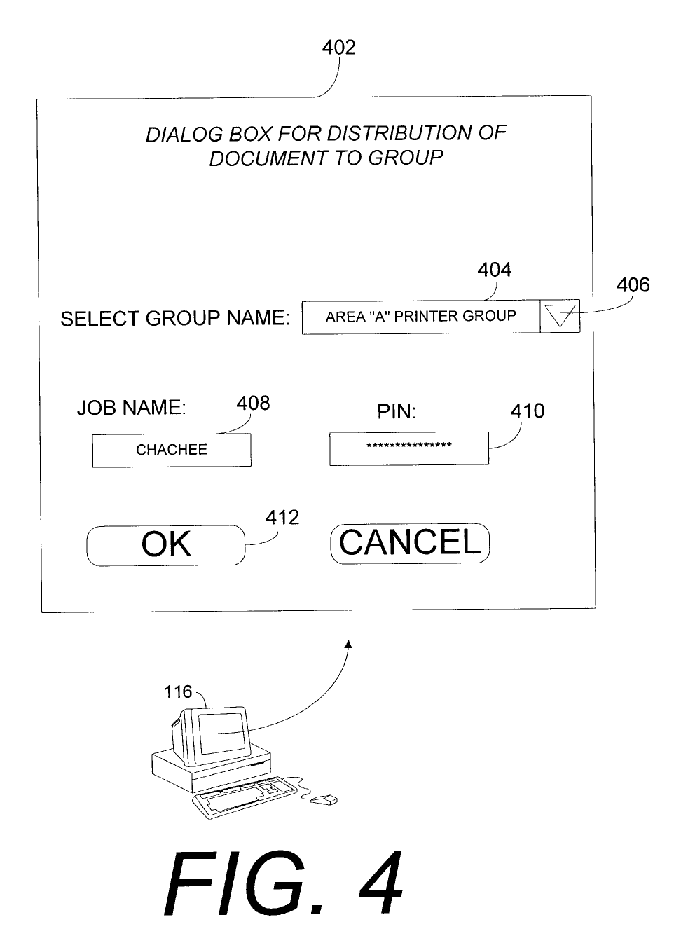

FIG. 4 illustrates a dialog box 402 that may be displayed at step 312. Referring briefly to FIG. 4, the dialog box 402 allows a user to select a defined printer subgroup by selecting the name assigned to the subgroup. The dialog box 402 shows the “AREA A PRINTER GROUP” as being presently selected.

If the user 103 selects an arrow icon 406, a “drop down” list of the other defined printer subgroups is displayed by name. The user can then select a different printer subgroup from this list.

Additionally, the user 103 can input a job name into an input field 408 and a PIN number into an input field 410. In this example, entry of the Job name and PIN number is optional. In this example, if the user inputs a PIN number, it is assumed that the user wishes to send a “private job” to each printer in the selected group. If, however, the user does not input a PIN number it is assumed that the user wishes to send a simple retention job to each printer in the selected group.

In the next part of this discussion, it is assumed that the user 103 interacts with the dialog displayed at step 312 in order to: a) select a defined printer subgroup; b) input a Job name; and c) input a PIN number. The application 124 receives this input at step 314. At step 316, the application 124 processes the input.

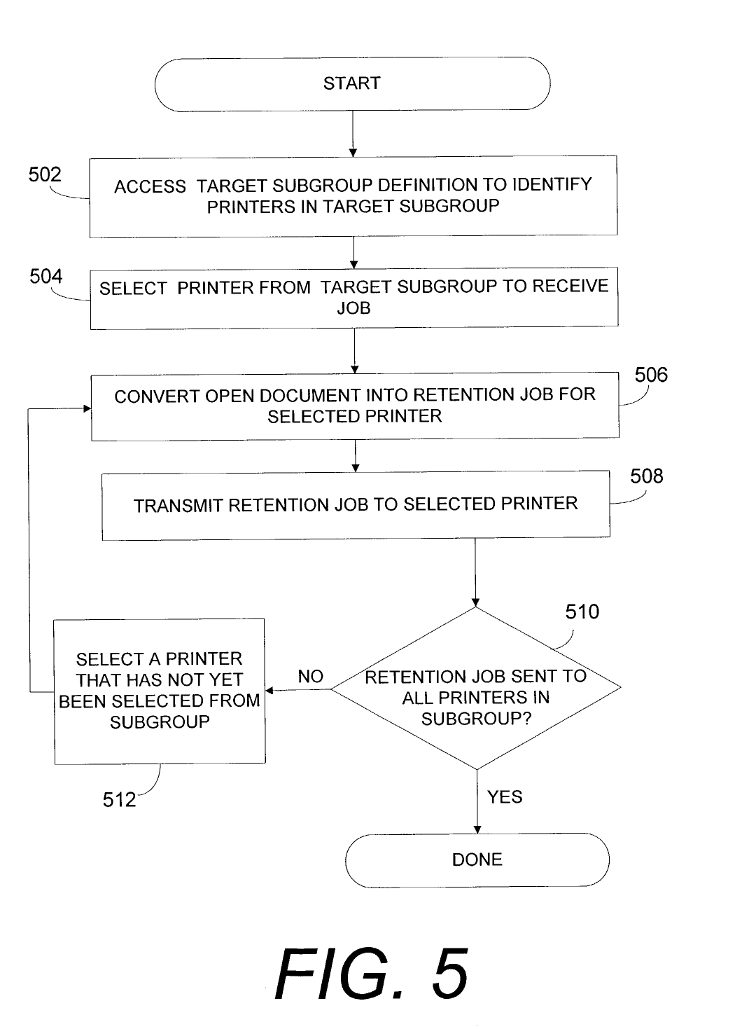

FIG. 5 is a flow diagram illustrating generally the steps performed by the computer 104, at the direction of the application 124, to process the input at step 316. For ease of the following discussion, the printer subgroup selected by the user 103 at step 314 may be referred to herein as the “TARGET SUBGROUP”.

Referring to FIG. 5, the computer 104 operates to access the definition of the TARGET SUBGROUP in order to identify the printers that are members of this particular subgroup (step 502). As noted above, the definition of a printer subgroup may be stored locally or on a network system. Thus, step 502 may be performed by accessing the TARGET SUBGROUP definition from local memory (e.g., the memory 122) or by retrieving the definition over the network 108 from, for example, a network server.

Next, the computer 104 automatically selects a printer from the TARGET SUBGROUP to receive a retention job (step 504). The application 124 then converts the document 140 into a retention job (step 506). The retention job generated at step 506 describes the document 140 and includes the appropriate commands to direct the selected printer to retain the job until a walk-up user releases the job. Releasing the job involves the walk-up user entering the specified PIN number. In this example, therefore, the retention job generated at step 506 is a “private job”.

Furthermore, in this example, the retention job generated at step 506 includes data that identifies the other printers in the TARGET SUBGROUP. The use of this data is described below.

At step 508, the computer 104 transmits the retention job, over the network 108, to the selected printer. The selected printer receives and stores the job in local memory until the job is released for printing (or deleted).

At step 510, the computer 104 determines if all printers in the TARGET SUBGROUP have received a retention job that describes the document 140. If so, the procedure ends. If not, the computer 104 proceeds to select a different printer in the TARGET SUBGROUP at step 512 and then repeats steps 506 and step 508. The computer 104 continues to operate in this manner until a retention job is sent to each one of the printers in the TARGET SUBGROUP.

According to one implementation, if the computer 104 is unable to communicate with one or more of the printers in the TARGET SUBGROUP, due to power loss or some other reason, the computer 104 displays a dialog box. The dialog box may provide certain helpful information to the user 103, such as, for example, which printer(s) were affected. The dialog box may also prompt the user for certain action.

### Document Retrieval

After the computer 104 has transmitted a retention job to each printer in the TARGET SUBGROUP, the user 103 now has the option to retrieve the document 140 from any one of these printers. In this example, once one of the retained jobs is printed the other jobs are automatically deleted. In other implementations, however, the other jobs are not deleted and/or the user is given the option to delete the other jobs. In still other implementations, the retained jobs that are not printed are deleted after a specified job expiration date has passed. In some cases, the user sets the job expiration date. In other cases, the job expiration data is determined automatically.

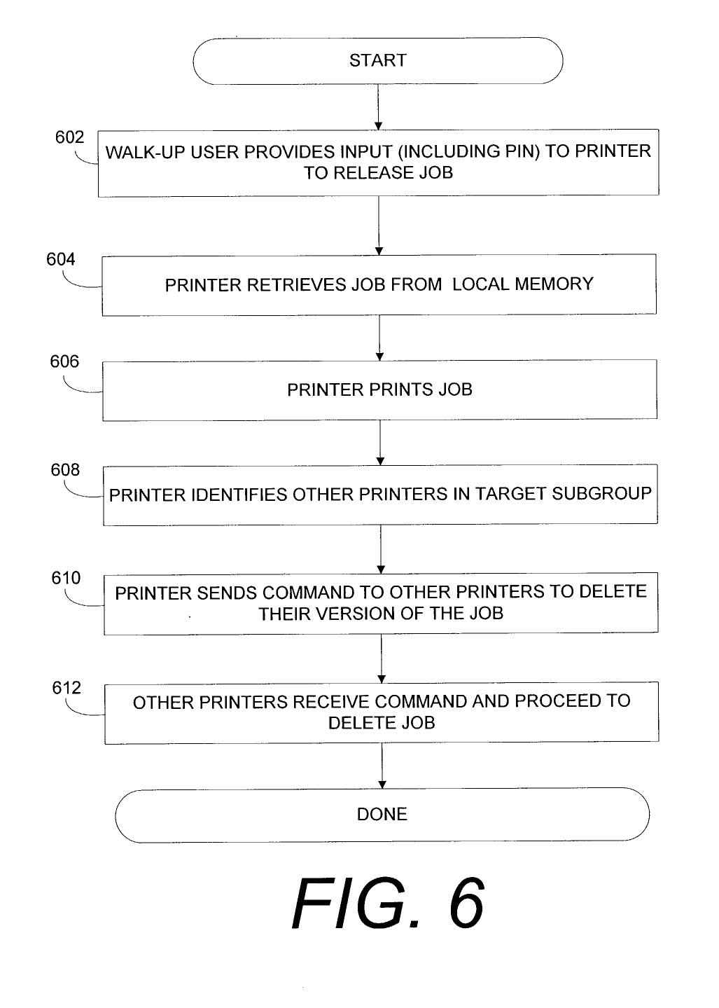

FIG. 6 is a flow diagram illustrating, by way of example, the operation of a printer in the TARGET SUBGROUP to print the document 140. In this example, it is assumed the computer 104 has performed the procedure of FIG. 5 to distribute a retention job that describes the document 140 to each printer in the TARGET SUBGROUP. Furthermore, it is assumed that the TARGET SUBGROUP is the “COLOR PRINTER GROUP” and that a user wishes to retrieve the document 140 from the third printer 210. As noted above, the third printer 210 is a member of the COLOR PRINTER GROUP.

Referring now to FIG. 6, a walk-up user (e.g., the user 103) provides the appropriate input to the third printer 210 in order to release the retained job that describes the document 140 (step 602). In this example, the input includes the job name and PIN number that was specified by the user 103 at step 314.

In response to the input received from the walk-up user, the third printer 210 operates to retrieve the appropriate retained job from local memory and then prints the job (steps 604 and step 606) thereby generating a printed copy of the document 140. Additionally, the third printer 210 reads the information included in the retained job that identifies the other printers in the TARGET SUBGROUP (step 608). Thus, in this case, the third printer 210 identifies the other printers in the COLOR PRINTER GROUP (i.e., printer 212, printer 214 and printer 216).

The third printer 210 then transmits a command, over the network 108, to all other printers in the COLOR PRINTER GROUP (Step 610). The command directs the receiving printer to delete their version of the retained job that the third printer 210 just printed. The command may include the job name in order to enable the printer to locate the appropriate job. The printers each receive the command and respond by deleting the appropriate job (step 612).

### Second Embodiment

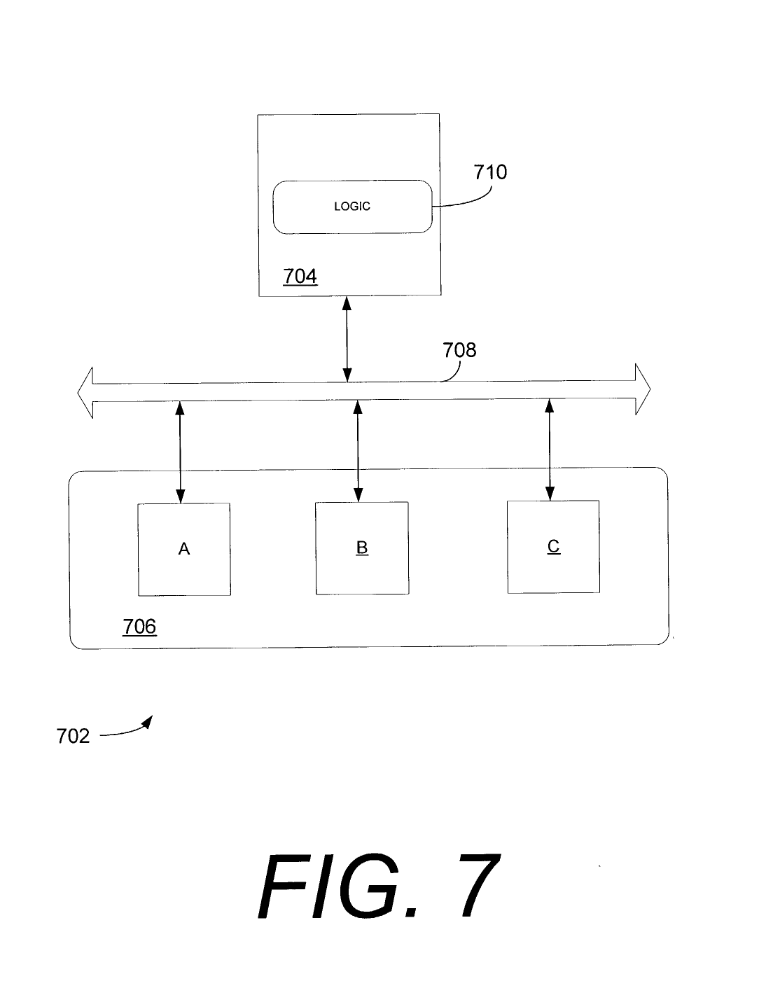

FIG. 7 shows a block diagram of a computing system 702 that is in accordance with a second embodiment of the invention. Referring to FIG. 7, the computing system includes a computer 704 and a group of retention printers 706 (printer “A”, “B” and “C”). The computer 704 can transmit print jobs to each of the printers 706 via a network system 708.

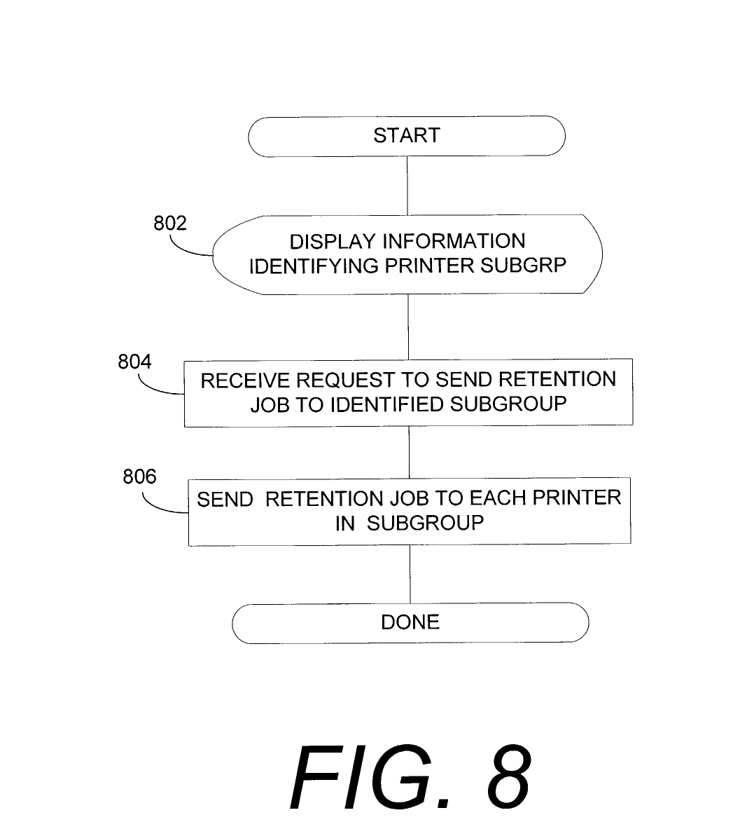

The computer 704 may represent any suitable computing device, such as a personal computer, laptop computer, PDA, etc. The computer 704 includes “logic” 710 that enables the computer 704 to perform the steps depicted in FIG. 8. The logic 710 may represent hardware and/or software components.

Referring to FIG. 8, the computer 704 displays information that identifies a subgroup of the printers (printer A and printer C) in the printer group 706 (step 802). Next, the computer 704 receives a request to send a retention job to each of the printers in the identified subgroup (step 804). In response to this request, the computer 704 operates to send a retention job to each of the printers in the identified printer subgroup (step 806). Thus, at step 806, the computer 704 sends a retention job to printer “A” and to printer “C”.

### Other Embodiments

It is noted that in some embodiments, a job may not be sent directly to each printer in a selected subgroup. For example, in alternative implementations of the computer system of FIG. 1, a retained job may be sent to a central server system (or even another retention printer) on the network 108 and each printer in the TARGET SUBGROUP is provided a reference to the job. A walk-up user can still print the job at any of the printers in the TARGET SUBGROUP by providing appropriate input. In response to this input, the printer reads the reference, retrieves the job over the network 108 and then prints the job.

This alternative configuration may result in reducing network traffic as compared to sending a retention job to each one of the printers in the TARGET SUBGROUP.

It is also noted that the present invention may be embodied in the form of a “computer-readable medium” that stores (either temporarily or permanently) computer executable instructions for performing the steps depicted in one or more of the flow diagrams described above. As used herein, the phrase “computer-readable medium” can refer to any medium that can contain, store or propagate computer executable instructions. Thus, in this document, the phrase “computer-readable medium” may refer to a medium such as a CD ROM or a magnetic storage device. The phrase “computer readable medium” may also refer to signals that are used to propagate the computer executable instructions over a network or a network system, such as the Public Internet.

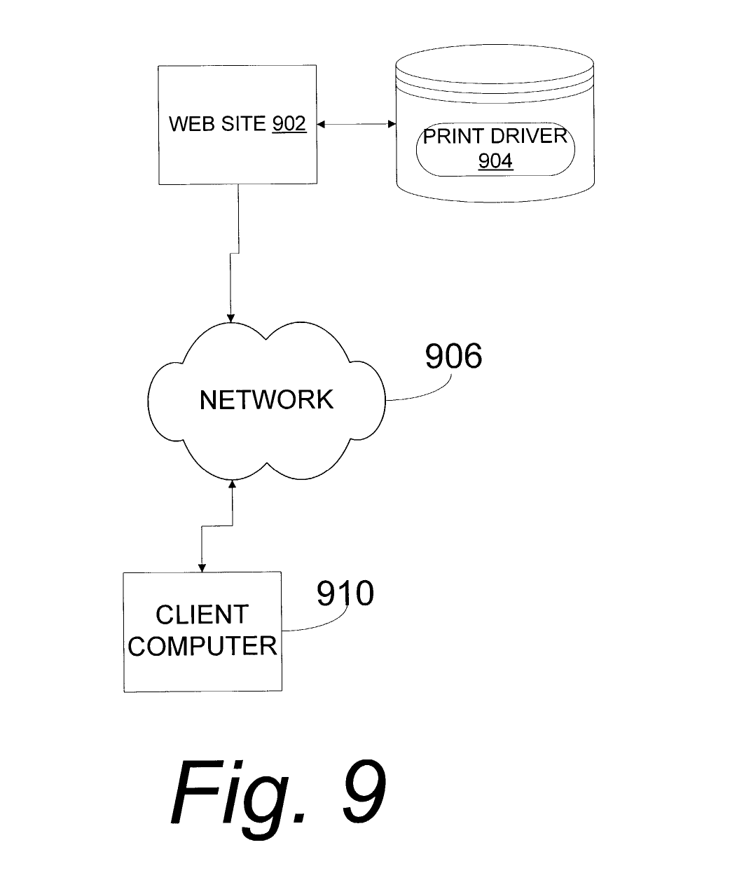

FIG. 9 illustrates, for example, yet another embodiment of the invention. FIG. 9 shows a WEB SITE 902 that can provide a copy of a print driver 904 over a network 906 to WEB Clients (e.g., WEB Client 910). The network 906 may represent, for example, the PUBLIC INTERNET. The printer driver 904 enables a computer to send a job to a defined printer subgroup in accordance with any of the embodiments described above. The signals used to propagate the print driver 904 over the network 906 are considered a computer readable medium and represent an embodiment of the invention.

Although several specific embodiments of the invention have been described and illustrated, the invention is not to be limited to specific forms or arrangements of parts so described and illustrated. The invention is limited only by the claims and the equivalents thereof.

What is claimed is:

1. A computer, comprising:
(a) means for displaying information identifying a subgroup of retention printers from a group of retention printers;
(b) means for receiving a request to make a particular document available at each retention printer in the subgroup; and
(c) means for responding to the request by transmitting a retention job that describes the document to each retention printer in the subgroup.

2. The computer of claim 1, wherein the subgroup includes at least two retention printers.

3. The computer of claim 2, wherein the subgroup is pre-defined and is assigned a name; and wherein the displaying means displays the assigned name.

4. The computer of claim 1, wherein the subgroup of retention printers are those retention printers, from the group of retention printers, that are located within a particular defined area.

5. The computer of claim 1, wherein the subgroup of retention printers are those retention printers from the group of retention printers that are physically located within a defined distance from a particular location.

6. The computer of claim 1, wherein the subgroup of retention printers are those retention printers from the group that are located within a defined distance from the computer.

7. In a computer, a method of enabling a group of printers to print a document, comprising:
(a) displaying Information that identifies a plurality of printer groups;
(b) receiving a request to distribute a document to a selected one of the printer groups; and
(c) in response to the request, transmitting a retention job that describes the document to each printer in the selected group.

8. The method of claim 7, wherein each printer from the plurality of printer groups is a retention printer.

9. The method of claim 7, wherein the computer displays the information in the form of a print dialog box.

10. A system, comprising:
(a) a plurality of retention printers each connected to a network system; and
(b) a computer connected to the network system; and
wherein the retention printers are logically organized into a plurality of subgroups;
wherein the computer provides a user interface that enables a user to select a subgroup and to request a document be retained at each printer in the selected subgroup;
wherein the computer is responsive to the request by transmitting a retention job that describes the document to each one of the printers in the selected subgroup.

11. The system of claim 10, wherein each printer in the selected subgroup is a retention printer.

12. The system of claim 11, wherein each of the plurality of subgroups is assigned a name; and
wherein the user interface indicates each name assigned to each of the plurality of subgroups.

13. A computer readable medium embodying instructions configured to:
(a) enable a computer to display information regarding a pre-defined group of retention printers; and
(b) enable the computer to receive a user request to make a document available at each printer in the pre-defined group.

14. The computer readable medium of claim 13, wherein the instructions are further configured to:
(c) enable the computer to respond to the request by transmitting a retention job to each one of the retention printers in the pre-defined group of retention printers.

15. A method comprising:
(a) providing a computer connected to a group of retention printers;
(b) identifying at least one subgroup of printers in the group of retention printers;
(c) receiving, by the computer, a user request, and
(d) responding, by the computer, to the request;
wherein the request directs the computer to make a particular document available at each printer in the at least one printer subgroup; and
wherein the responding step includes the substep of configuring each printer in the at least one printer subgroup to print the document in response to input received from a walk-up user.

16. The method of claim 15, wherein the configuring substep is performed by transmitting a retention job to each printer in the at least one printer subgroup.

17. In a system that includes an identified group of retention printers, a method comprising:
(a) receiving, by a first printer in the group, a retention job;
(b) detecting, by the first printer, at least one event;
(c) transmitting, by the first printer, a command to all other printers in the group;
wherein step (c) is performed in response to step (b);
wherein each printer in the group also received a copy of the retention job; and
wherein each printer in the group is responsive to the command by deleting their copy of the retention job.

18. The method of claim 17, wherein the at least one event includes the event of printing, by the first printer, the job.

19. The method of claim 17, wherein the at least one event includes the event of receiving, by the first printer, a request to print the job.

20. A method, comprising:
(a) receiving, by a computer, a request to make a document available at each printer in a group of printers; and
(b) responding, by the computer, to the request; and
wherein step (b) includes the following substeps:
(b. 1) storing a print job that describes the document on a remote device; and
(b.2) enabling each printer in the group to, at the request of a walk-up user, retrieve the print job from the remote device and to then print the job.

21. The method of claim 20, wherein the remote device is a retention printer.
